(19) United States
(12) Patent Application Publication
(10) Pub. No.: US 2020/0168167 A1
(43) Pub. Date: May 28, 2020

(54) OPTICAL COMPENSATION METHOD OF A DISPLAY PANEL AND ASSOCIATED SYSTEM

(71) Applicant: INCOFLEX SEMICONDUCTOR TECHNOLOGY CO., LTD., Shaanxi (CN)

(72) Inventor: KUN-HUA TSAI, SHAANXI (CN)

(21) Appl. No.: 16/698,247

(22) Filed: Nov. 27, 2019

(30) Foreign Application Priority Data
Nov. 27, 2018 (CN) 201811423852.6

(51) Int. Cl. G09G 3/34; G09G 5/10; G09G 3/3208

(52) U.S. Cl. CPC G09G 3/3406; G09G 5/10; G09G 2320/0646; G09G 2320/0233; G09G 3/3208

(57) ABSTRACT

An optical compensation method of a display panel, wherein the method includes providing an external assembly and a cloud server; obtaining a brightness image of a panel to be corrected by the external assembly; transmitting the brightness image stored in the external assembly and a serial number corresponding to the panel to be corrected to the cloud server, and recording the brightness image and the serial number as marked data; and performing an algorithm via the cloud server to generate a brightness-compensation data of the panel to be corrected based on the marked data, and storing the brightness-compensation data.

### TECHNICAL FIELD

The present disclosure relates to a defect compensation technique for a display panel, and more specifically, to a method for resolving the uneven brightness resulting from optical defect of a display panel.

### BACKGROUND ART

The display technology has evolved considerably, and the product lifetime of the illuminating material of organic light-emitting diodes (OLED) has grown. As a result. OLED displays have been widely sold on global markets. Current OLED displays can be categorized as rigid-type displays or flexible-type displays. The rigid-type OLED display utilizes a glass substrate, while the flexible-type OLED display utilizes flexible material as a substrate. For example, the flexible-type OLED display usually utilizes polyimide as a substrate.

An active-matrix OLED (AMOLED) panel includes a thin-film transistor layer and an OLED layer, wherein the thin-film transistor layer is composed of a plurality of thin-film transistors while the OLED layer corresponds to the plurality of thin-film transistors. The OLED layer includes a plurality of OLEDs arranged in a matrix, wherein each OLED is considered a subpixel. Each subpixel is driven by a corresponding thin-film transistor. Because the OLED is an element driven by current, a tiny difference between the thin-film transistors may result in a great difference of brightness on a display panel. In addition, the difference between the characteristics of the OLED and the thin-film transistor may result in an uneven brightness of the OLED module. Such problem is referred to as the mura issue.

In the OLED panel, the subpixel circuit is arranged to compensate for the variation of the threshold voltage of the thin-film transistor. However, this compensation is not able to compensate for the variations of other parameters of the thin-film transistor or the variations of characteristics of the OLED. Therefore, display producers use external compensation methods, known as demura techniques, to perform optical compensation and equalize the brightness of the OLEDs. The external compensation methods can be categorized as electrical detection compensation or optical detection compensation.

The external electrical detection compensation includes steps of providing a voltage to each OLED display pixel by an external driving circuit, detecting the current-voltage (I-V) characteristic of each display pixel, and calculating a compensation coefficient for each subpixel, to correct the image data. Because the electrical detection compensation detects the electrical characteristics of the thin-film transistor or OLED in advance, it cannot detect the brightness difference displayed by the OLED. Therefore, the uneven brightness cannot be corrected.

The external optical detection compensation detects the brightness information of each subpixel in the OLED panel via an optical device. The external optical detection compensation includes the following steps: Step A, recording brightness information of each subpixel in an OLED panel with an accurate optical device; Step B, calculating and generating a compensation coefficient of each subpixel; Step C, compressing the compensation coefficient and storing the compensation coefficient in a flash memory; Step D, reading, by a driving circuit, the compensation information from the flash memory, decompressing the compensation information, correcting the image data according to the compensation information, and providing the corrected image data to the OLED. However, the external optical detection compensation requires an optical device with high resolution to detect the brightness of each subpixel. An optical device with four times display resolution is recommended. With such high resolution, more time and storage capacity are required for operations such as capturing images, calculation, data transmission, etc. In addition, a signal connection board (X/B) in an display device usually utilizes a flash storage integrated circuit (IC) to store configuration data. The configuration data is a data when the display panel operates normally. For example, the configuration data is an overdrive data, a mura data, a white balance data or a color misregistration data. The flash storage IC on the signal connection board increases the size of the signal connection board, which presents difficulty in the integration of the display device.

### SUMMARY

According to an embodiment of the present disclosure, an optical compensation method of a display panel is disclosed. The method includes providing an external assembly and a cloud server; obtaining a brightness image of a panel to be corrected by an external assembly; transmitting the brightness image stored in the external assembly, and a serial number corresponding to the panel to be corrected, to a cloud server; recording the brightness image and the serial number as marked data; performing an algorithm via the cloud server to generate a brightness-compensation data of the panel to be corrected based on the marked data; and storing the brightness-compensation data.

According to an embodiment of the present disclosure, an optical compensation method of a display panel is disclosed. The method includes providing a brightness capture device, an operation-processor, and a cloud server; obtaining a brightness image of a panel to be corrected by the brightness capture device; receiving the brightness image and a serial number of the panel to be corrected from the operation-processor; recording the brightness image and the serial number as marked data, wherein the operation-processor is configured to generate a brightness-compensation data of the panel to be corrected according to an algorithm; uploading the brightness-compensation data of the panel to be corrected to the cloud server via the internet; and storing the brightness-compensation data.

According to an embodiment of the present disclosure, an optical compensation method of a display panel is disclosed. The method includes providing an external assembly and a cloud server; obtaining a brightness data and a serial number from a panel to be corrected via the external assembly; recording the brightness data and the serial number as marked data of the panel to be corrected; executing, by the external assembly, an algorithm upon the marked data of the panel to be corrected to generate a brightness-compensation data corresponding to the marked data; uploading the brightness-compensation data of the panel to be corrected from the external assembly to the cloud server; and storing the brightness-compensation data.

According to an embodiment of the present disclosure, an optical compensation system is disclosed. The optical compensation system includes a display panel, a external assembly and a cloud server. The external assembly includes an image sensor and a transmitter circuit, wherein the image sensor is arranged to capture an image of the display panel and the transmitter circuit is arranged to transmit the image of the display panel. The cloud server includes a receiver circuit, a storage device and a process circuit. The receiver circuit is arranged to receive the image of the display panel and a serial number corresponding to the display panel from the transmitter circuit of the functional assembly. The storage device is arranged to store the image and the serial number as marked data. The process circuit is arranged to perform an algorithm to generate a brightness-compensation data for the display panel.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a diagram illustrating a configuration of an assembly for a data-transmission method according to an embodiment of the present disclosure.

FIG. 1B is a flowchart illustrating the embodiment of FIG. 1A.

FIG. 2A is a diagram illustrating a configuration of an assembly for a data-transmission method according to another embodiment of the present disclosure.

FIG. 2B is a flowchart illustrating the embodiment of FIG. 2A.

FIG. 3A is a diagram illustrating a configuration of an assembly for a data-transmission method according to yet another embodiment of the present disclosure.

FIG. 3B is a flowchart illustrating the embodiment of FIG. 3A.

FIG. 4 is a diagram illustrating a cloud server recording ID information of panels according to an embodiment of the present disclosure.

FIG. 5 is a diagram illustrating an optical compensation system according to an embodiment of the present disclosure.

### EMBODIMENTS

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

As used herein, spatially relative terms, such as “beneath.” “below,” “above,” “over,” “on,” “upper,” “lower,” “left,” “right,” “vertical,” “horizontal,” “side” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. It should be understood that when an element is referred to as being “connected to” or “coupled to” another element, it may be directly connected to or coupled to the other element, or intervening elements may be present.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Mura defect is a common phenomenon existing in display devices due to uneven brightness. When a display device displays images on a screen with mura defect, the information observed by a user includes original content and mura information. The mura information affects the user's experience, therefore, a demura method is usually adapted to suppress the mura defect. The demura method includes steps of obtaining a demura compensation coefficient by analyzing the mura information on a screen; adjusting the display content, i.e., performing a demura process; and suppressing and eliminating the mura information to improve viewability of the display content. The demura process includes calibrating the display content on the screen via a standard whitefield gray level signal; obtaining locations on the screen that are relatively bright in response to the display content under the standard whitefield gray level; using the demura compensation coefficient to reduce brightness at screen locations that are relatively bright in response to the display content and increase brightness at screen locations that are relatively dim in response to the display content; and suppressing on-screen mura defects at each gray level through the aforementioned steps.

The embodiments of the present disclosure provide an optical compensation method of a display panel. The method includes reading, from the functional elements which different from the panel to be corrected, the demura compensation data of a panel to be corrected, and performing mura defect compensation on the panel to be corrected according to demura compensation data. The method further includes reading, from a plurality of data transmission paths, the demura compensation data of the panel to be corrected without using a storage unit on the panel to be corrected, wherein the plurality of data transmission paths are composed by functional elements different from the panel to be corrected. As a result, the device size and manufacturing cost of are reduced.

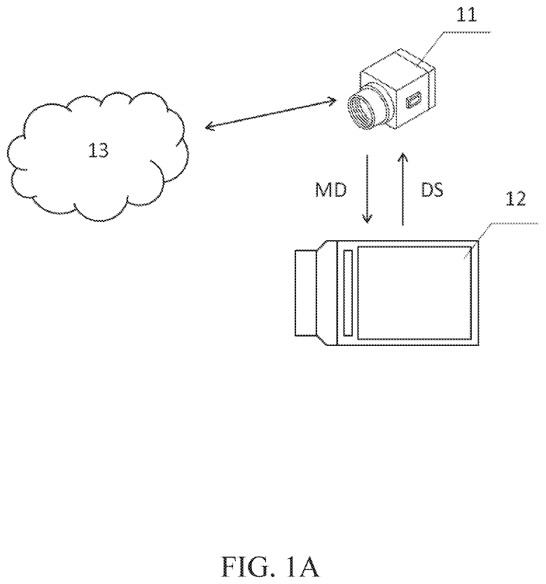

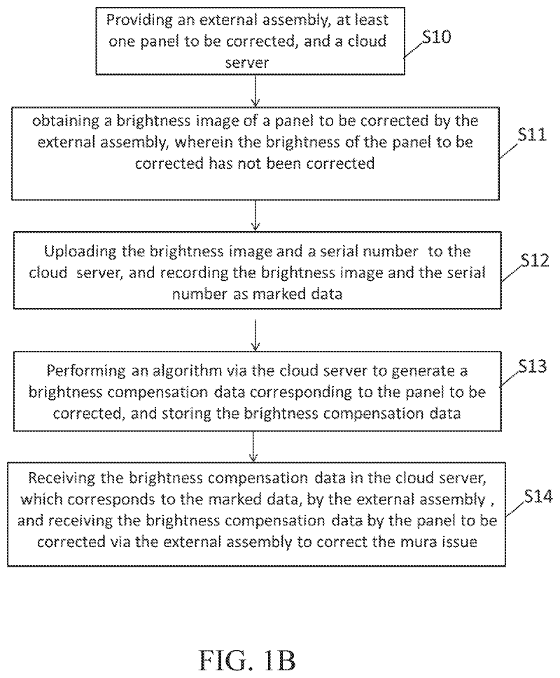

FIGS. 1A and 1B respectively illustrate a configuration of an assembly and a flowchart of a data-transmission method according to an embodiment of the present disclosure. As shown in FIGS. 1A and 1B, in this embodiment, the method mainly includes a mura data upload procedure, a compensation data download procedure, and a demura operation on a panel to be corrected through operations S11, S12, S13 and S14. The method includes an operation S10 for providing an external assembly 11, at least one panel to be corrected 12, and a cloud server 13.

In operation S11, a brightness image DS of the panel to be corrected 12 is obtained by an external assembly 11, wherein the brightness of the panel to be corrected 12 has not been corrected.

The external assembly 11 is configured as a computer-readable medium with a charge-coupled device (CCD) for capturing images. The computer-readable medium can be included in the aforementioned devices or systems, or as a standalone system not installed in any device. The computer-readable medium performs one or more procedures, which form part of the method in this embodiment.

In operation S12, the brightness image DS and a serial number corresponding to the panel to be corrected 12 are uploaded to the cloud server 13 via the internet, and are recorded as marked data.

Specifically, a mura information of each panel to be corrected, e.g., the panel to be corrected 12, corresponds to a driver ID which is written into a one-time programmable (OTP) memory of a driver IC because of the small size of the driver ID. The driver ID is received and stored by the external assembly 11.

In operation S13, an algorithm is performed via the cloud server 13 to generate a brightness-compensation data MD corresponding to the panel to be corrected 12, and the brightness-compensation data MD is stored.

Specifically, the cloud server 13 includes a process circuit, for example, a general microprocessor, an instruction-set processor, an associated IC set, and/or a special microprocessor (e.g., an ASIC). The process circuit may further include an onboard memory serving as a cache. The process circuit is a single process unit or multiple process units arranged to perform operations in this embodiment. The process circuit can calculate the brightness uniformity of the brightness image DS. The process circuit can further select a reference point of brightness for comparing the brightness of pixels with the mura issue, and can adjust gray level values or voltages of the pixels with the mura issue to increase the brightness of areas that are relatively dim and decrease the brightness of areas that are relatively bright. The display can be equalized accordingly.

When the demura technique is adapted, good display effect and short operation time are both required. Therefore, an effective and practical demura algorithm is necessary. The demura algorithm used by the process circuit of the cloud server 13 includes estimating the amended gray level value according to a gamma value and a target brightness. With an OLED display panel, a single estimation is performed according to a unified gamma value or gamma curve to generate the brightness-compensation data MD to correct the mura issue.

In operation S14, the brightness-compensation data MD in the cloud server 13, which corresponds to the marked data, is received by the external assembly 11 via the internet, and the brightness-compensation data MD is received by the panel to be corrected 12 via the external assembly 11 to correct the mura issue.

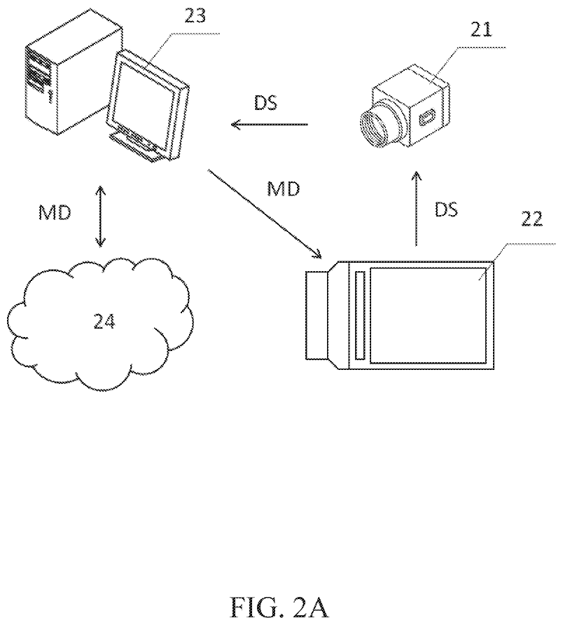

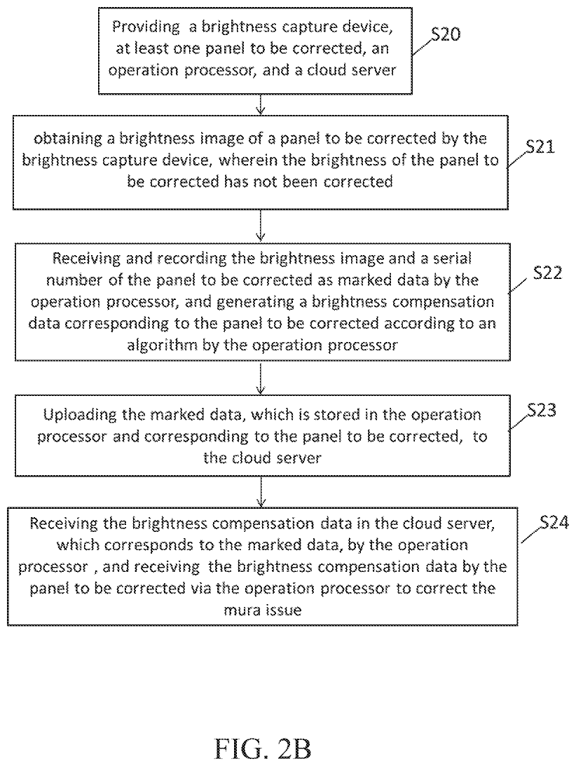

FIGS. 2A and 2B respectively illustrate a configuration of an assembly and a flowchart of a data-transmission method according to another embodiment of the present disclosure. As shown in FIGS. 2A and 2B, in this embodiment, the method mainly includes a mura data upload procedure, a compensation data download procedure, and a demura operation on the panel to be corrected through operations S21, S22, S23 and S24. The method includes an operation S20 for providing a brightness capture device 21, at least one panel to be compensated 22, an operation-processor 23 and a cloud server 24.

In operation S21, a brightness image DS of a panel to be corrected 12 is obtained by the brightness capture device 21, which is a CCD for capturing images, wherein the brightness of the panel to be corrected 22 has not been corrected.

In operation S22, the brightness image DS and a serial number of the panel to be corrected 22 are received, and are recorded as marked data by the operation-processor 23, and a brightness-compensation data corresponding to the panel to be corrected 22 is generated according to an algorithm by the operation-processor 23.

Specifically, a mura information of each panel to be corrected, e.g., the panel to be corrected 22, corresponds to a driver ID which is written into an OTP memory of a driver IC because of the small size of the driver ID. The driver ID is received and stored by the operation-processor 23. The operation-processor 23 includes a process circuit, for example, a general microprocessor, an instruction-set processor, an associated IC set, and/or a special microprocessor (e.g., an ASIC). The process circuit may further include an onboard memory serving as a cache. The process circuit is a single process unit or multiple process units arranged to perform the operations in this embodiment. The process circuit can calculate the brightness uniformity of the brightness image DS. The process circuit can further select a reference point of brightness for comparing the brightness of pixels with the mura issue, and adjust gray level values or voltages of the pixels with the mura issue to increase the brightness of areas that are relatively dim and decrease the brightness of areas that are relatively bright. The display can be corrected accordingly.

When the demura technique is adapted, good display effect and short operation time are both required. Therefore, an effective and practical demura algorithm is necessary. The demura algorithm used by the process circuit of the operation-processor 23 includes estimating the amended gray level value according to a gamma value and a target brightness. With an OLED display panel, a single estimation is performed according to a unified gamma value or gamma curve to generate the brightness-compensation data MD and correct the mura issue.

In operation 23, the marked data, which is stored in the operation-processor 23 and corresponds to the panel to be corrected 22, is uploaded to the cloud server 24 via the internet.

In this embodiment, the cloud server 24 includes a process circuit, for example, a general microprocessor, an instruction-set processor, an associated IC set, and/or a special microprocessor (e.g., an ASIC).

In operation S24, the brightness-compensation data MD in the cloud server 24, which corresponds to the marked data, is received by the operation-processor 23 via the internet, and the brightness-compensation data MD is received by the panel to be corrected 22 via the operation-processor 23 to correct the mura issue.

The process circuit in the operation-processor 23 or the cloud server 24 can be a medium capable of containing, storing or transmitting instructions. For example, the process circuit can be a readable storage medium, a semiconductor system, a device, an element or a transmission medium, wherein the readable storage medium includes but is not limited to electronic, magnetic, optic, electromagnetic, or infrared media.

The exemplary embodiments of the readable storage medium include: a magnetic storage device such as a cassette tape or hard disk drive (HDD); an optical storage device such as compact disc; a memory such as a random access memory (RAM) or flash memory; and/or a wired/wireless communication link. The readable storage medium can further include a computer program. The computer program can include a program code/computer-executable instruction that, when loaded and executed by the process circuit, instructs the process circuit to perform the method of this embodiment. The computer program code can include one or more program modules.

It should be noted that the number of the modules and how to define a module are not a limitation of the present disclosure. Those skilled in the art can choose the suitable program module or the suitable program module set in accordance with the actual situation. When loaded and executed by the process circuit, the program module or the program module set instructs the process circuit to perform the method of this embodiment or other alternative designs.

In the present disclosure, the process circuit of the operation-processor 23 or the cloud server 24 can be a tangible medium including or storing a program, wherein the program can be used by an instruction-execution system, a device, an element, or a combination thereof. In the present disclosure, the computer-readable signal medium may include a data signal transmitted in baseband or as a part of a carrier, wherein the data signal carries a computer-readable program code. The data signal can be in many forms which include but are not limited to electromagnetic signal, optic signal or the combination thereof. The computer-readable signal medium can further be a computer-readable medium, which is capable of transmitting a program used by an instruction-execution system, a device, an element or a combination thereof. The program code included in the computer-readable medium can be transmitted in any suitable medium, which includes but is not limited to wireless, wire, optical cable, radio frequency (RF) signal, etc.

The panel to be corrected 12 and 22 may not include a storage unit for storing the compensation data. When the electronic device turns on, the computer-readable medium or the operation-processor can read the marked data of the panel to be corrected, such as the driver ID of the panel to be corrected. The computer-readable medium or the operation-processor can communicate with the cloud server to transmit the marked data corresponding to the panel to be corrected to the cloud server or server cluster and request the brightness-compensation data MD of each panel to be corrected. When the brightness-compensation data is successfully received from the cloud server, the computer-readable medium or the operation-processor can transmit the brightness-compensation data MD to a display drive IC (not shown in figure) of the panel to be corrected to equalize the display content. In the methods in the abovementioned embodiments, the compensation data is obtained from the marked data of the display module without storing the compensation data in the panel to be corrected and the flash storage IC. Therefore, the size of the device is reduced and the manufacturing cost is decreased.

The panel to be corrected can include a storage assembly. The storage assembly stores compressed data corresponding to the compensation data which cannot be used by the display drive IC. When the electronic device turns on, the computer-readable medium or the operation-processor reads the compressed data from the storage assembly and decompresses the compressed data. The computer-readable medium or the operation-processor then further uploads the compressed data to the cloud server for storage. The compensation data is obtained after the algorithm is performed by the cloud server, and the compensation data is transmitted to the drive IC of the panel to be corrected to equalize the display content. Since the storage assembly only stores the compressed data, the size of the storage assembly can be relatively small compared to the existing storage units. Therefore, the size of the device is reduced and the manufacturing cost is decreased correspondingly.

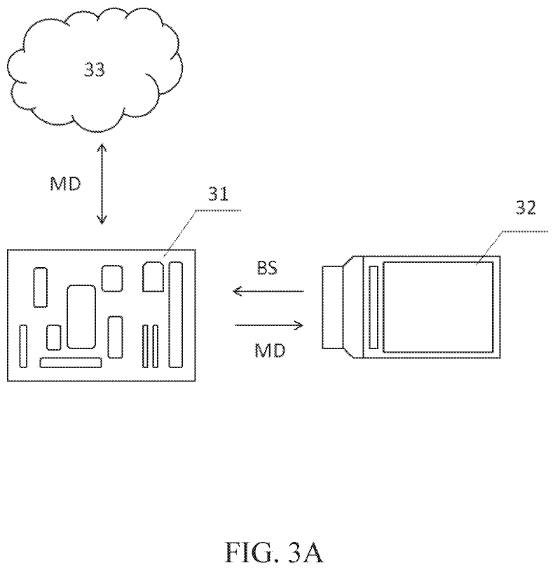

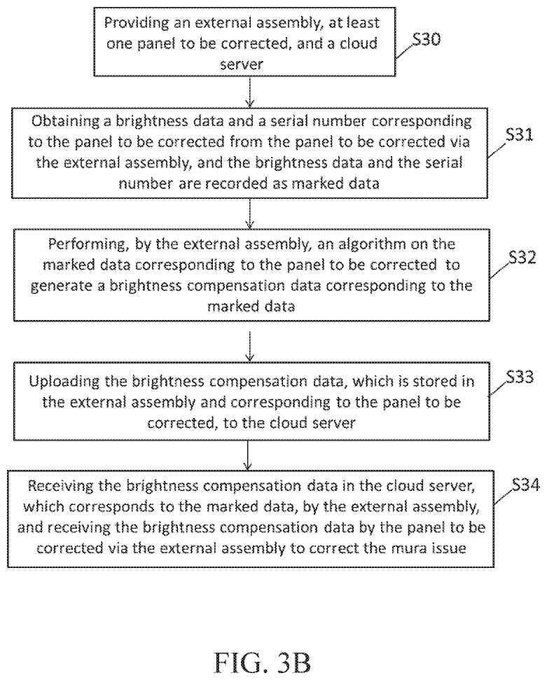

FIGS. 3A and 3B respectively illustrate a configuration of an assembly and a flowchart of a data-transmission method according to yet another embodiment of the present disclosure. As shown in FIGS. 3A and 3B, in this embodiment, the method mainly includes a mura data upload procedure, a compensation data download procedure, and a demura operation on the panel to be corrected through operations S31, S32, S33 and S34. In operation, the method includes an operation S30 for providing an external assembly 31, at least one panel to be corrected 32 and a cloud server 33.

In operation 31, a brightness data BS and a serial number corresponding to the panel to be corrected 32 are obtained from the panel to be corrected 32 via the external assembly 31, and the brightness data BS and the serial number are recorded as marked data.

At least a part of the external assembly 31 can be implemented by hardware, which may include a field-programmable gate array (FPGA), a programmable logic array (PLA), a system-on-chip (SOC), a system on board, a system on package, or an ASIC. The external assembly 31 can also be implemented by software, hardware, firmware or the combination thereof. In this embodiment, the external assembly 31 is a pattern generator (PG).

In operation S32, an algorithm is performed on the marked data corresponding to the panel to be corrected 32 by the external assembly 31 to generate a brightness-compensation data MD corresponding to the marked data.

The PG can calculate the brightness uniformity of the brightness-compensation reference data BS. The PG can further select a reference point of brightness for comparing the brightness of pixels with the mura issue to calculate the required brightness-compensation data, and adjust gray level values or voltages of the pixels with the mura issue to increase the brightness of areas that are relatively dim and decrease the brightness of areas that are relatively bright. The display can be equalized accordingly.

In operation S33, the brightness-compensation data MD, which is stored in the external assembly 31 and corresponds to the panel to be corrected 32, is uploaded to the cloud server 33 via the internet.

When the demura technique is applied, good display effect and short operation time are both required. Therefore, an effective and practical demura algorithm is necessary. The demura algorithm used by the PG includes estimating the amended gray level value according to a gamma value and a target brightness. With an OLED display panel, a single estimation is performed according to a unified gamma value or gamma curve to generate the brightness-compensation data MD to correct the mura issue.

In an embodiment, the cloud server 33 includes a process circuit, for example, a general microprocessor, an instruction-set processor, an associated IC set and/or a special microprocessor (e.g., ASIC). The process circuit may further include an onboard memory serving as a cache.

In operation 34, the brightness-compensation data MD in the cloud server 33, which corresponds to the marked data, is received by the external assembly 31 via the internet, and the brightness-compensation data MD is received by the panel to be corrected 32 via the external assembly 31 to correct the mura issue.

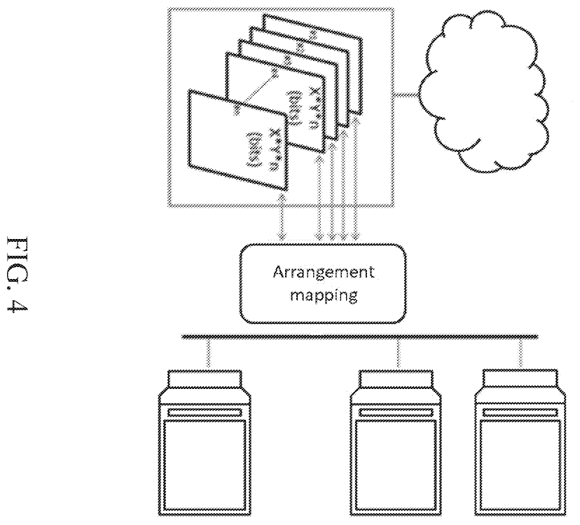

FIG. 4, which is a diagram illustrating the cloud server recording the serial numbers of a plurality of panels to be corrected. It should be noted that the serial number is a driver ID corresponding to the mura information of each panel. The driver ID is written to an OTP memory of a driver IC because of the small size of the driver ID. When the device turns on, the system obtains the driver ID, and requests the cloud server for the mura information of the panel. The mura information is mapping to the cloud server, and is downloaded by the system to correct the mura issue. The cloud server can use a fast area search algorithm of a virtual network mapping, for example, a permutation and exchange method.

One of the objectives of the present disclosure is to conserve room for a display area of the display panel by discarding or reducing the size of the demura flash memory in the display panel. The present disclosure proposes a plurality of data-transmission methods for demura including uploading the mura compensation information of the panel to the cloud server via a camera, a computer or a pattern generator. The methods proposed by the present disclosure includes advantages such as:
1. The back-end operation time for factories can be reduced by connecting a camera to the internet to upload data (i.e., the mura compensation information) to the cloud server for processing and storage.
2. The back-end operation time for factories can be reduced by connecting a computer to the internet to upload data (i.e., the mura compensation information) to the cloud server for processing and storage.
3. The back-end operation time for factories can be reduced by connecting a PG to the internet to upload data (i.e., the mura compensation information) to the cloud server for processing and storage.
4. The processing time and the cost of hardware can be reduced by deploying a corresponding algorithm in the cloud server.

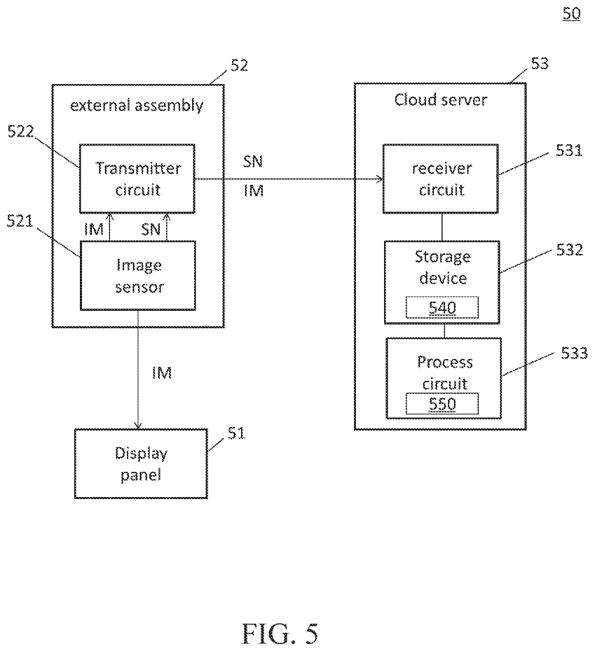

FIG. 5 is a diagram illustrating an optical compensation system 50 according to an embodiment of the present disclosure. As shown in FIG. 5, the optical compensation system 50 includes a display panel 51, an external assembly 52, and a cloud server 53. The display panel 51 can be implemented by the panel to be corrected 12, 22 and 32 mentioned above. The external assembly 52 includes an image sensor 521 and a transmitter circuit 522. The image sensor 521 is arranged to capture an image IM of the display panel 51. The transmitter circuit 522 is arranged to transmit the image IM and a serial number SN corresponding to the display panel 51 to the cloud server 53 via the internet. In this embodiment, the external assembly 52 can be implemented by the external assembly 11, 31 or the brightness capture device 21.

The cloud server 53 includes a receiver circuit 531, a storage device 532 and a process circuit 533. The receiver circuit 531 is arranged to receive the image IM and the serial number SN from the transmitter circuit 522. The storage device 532 is arranged to store the image IM and the serial number SN as marked data 540. The process circuit 533 is arranged to perform an algorithm to generate a brightness-compensation data 550 for the display panel 51. In addition, the storage device 532 is further arranged to store the brightness-compensation data 550. Those skilled in the art should readily understand the operation of the optical compensation system 50 after reading the paragraphs above; therefore, detailed description thereof is omitted here for brevity.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical compensation method of a display panel, comprising:
providing an external assembly and a cloud server;
obtaining a brightness image of a panel to be corrected, by the external assembly;
transmitting the brightness image stored in the external assembly and a serial number corresponding to the panel to be corrected to the cloud server, and the brightness image and the serial number are recorded as marked data; and
performing an algorithm via the cloud server to generate a brightness-compensation data of the panel to be corrected based on the marked data, and storing the brightness-compensation data.

2. The method of claim 1, wherein the brightness image and the serial number are transmitted to the cloud server via the internet.

3. The method of claim 1, wherein the external assembly is configured to be a computer-readable medium with a charge-coupled device (CCD) for capturing images.

4. The method of claim 1, wherein the external assembly receives the brightness-compensation data, which corresponds to the marked data, from the cloud server, and the panel to be corrected receives the brightness-compensation data via the external assembly to execute optical compensation.

5. The method of claim 1, wherein the algorithm comprises estimating an amended gray level value according to a gamma value and a target brightness, and performing a single estimation according to a unified gamma value or gamma curve to generate the brightness-compensation data.

6. An optical compensation method of a display panel, comprising:
providing a brightness capture device, an operation processor, and a cloud server;
obtaining a brightness image of a panel to be corrected by the brightness capture device;
receiving the brightness image and a serial number of the panel to be corrected from the operation-processor, and the brightness image and the serial number are marked as marked data, wherein the operation-processor is configured to generate a brightness-compensation data of the panel to be corrected according to an algorithm; and
uploading the brightness-compensation data of the panel to be corrected to the cloud server, and storing the brightness-compensation data.

7. The method of claim 6, wherein the brightness-compensation data of the panel to be corrected are uploaded to the cloud server via the internet.

8. The method of claim 6, wherein the brightness capture device is configured to be a charge-coupled device (CCD) for capturing images.

9. The method of claim 6, wherein the operation-processor receives the brightness-compensation data, which corresponds to the marked data, from the cloud server, and the panel to be corrected receives the brightness-compensation data via the operation-processor to execute optical compensation.

10. The method of claim 6, wherein the algorithm comprises estimating an amended gray level value according to a gamma value and a target brightness, and performing a single estimation according to a unified gamma value or gamma curve to generate the brightness-compensation data.

11. An optical compensation method of a display panel, comprising:
providing an external assembly and a cloud server;
obtaining a brightness data and a serial number from a panel to be corrected via the external assembly, and recording the brightness data and the serial number as marked data of the panel to be corrected;
performing an algorithm on the marked data of the panel to be corrected via the external assembly to generate a brightness-compensation data corresponding to the marked data; and
uploading the brightness-compensation data of the panel to be corrected which is stored in the external assembly to the cloud server, and storing the brightness-compensation data.

12. The method of claim 11, wherein the brightness-compensation data are uploaded to the cloud server via the internet.

13. The method of claim 11, wherein the external assembly comprises a pattern generator.

14. The method of claim 11, wherein the external assembly receives the brightness-compensation data, which corresponds to the marked data, from the cloud, and the panel to be corrected receives the brightness-compensation data via the external assembly to execute optical compensation.

15. The method of claim 11, wherein the algorithm comprises estimating an amended gray level value according to a gamma value and a target brightness, and performing a single estimation according to a unified gamma value or gamma curve to generate the brightness-compensation data.

16. An optical compensation system, comprising:
a display panel;
an external assembly, comprising:
an image sensor, arranged to capture an image of the display panel; and
a transmitter circuit, arranged to transmit the image of the display panel via the internet; and
a cloud server, comprising:
a receiver circuit, arranged to receive the image of the display panel and a serial number corresponding to the display panel from the transmitter circuit of the external assembly;
a storage device, arranged to store the image and the serial number as marked data; and
a process circuit, arranged to perform an algorithm to generate a brightness-compensation data for the display panel.

17. The optical compensation system of claim 16, wherein the storage device is further arranged to store the brightness-compensation data.
